(19) United States
(12) Patent Application Publication
(10) Pub. No.: US 2024/0406911 A1
(43) Pub. Date: Dec. 5, 2024

(54) TERMINAL AND RADIO COMMUNICATION METHOD

(71) Applicant: NTT DOCOMO, INC., Tokyo (JP)

(72) Inventors: Kousuke Shima, Tokyo (JP); Masaya Okamura, Tokyo (JP); Tomoya Ohara, Tokyo (JP); Hiroki Harada, Tokyo (JP)

(73) Assignee: NTT DOCOMO, INC., Tokyo (JP)

(21) Appl. No.: 18/693,839

(22) PCT Filed: Sep. 30, 2021
(86) PCT No.: PCT/JP2021/036284

§ 371 Date: Mar. 20, 2024

(51) Int. Cl. H04W 64/00; G01S 5/00; G01S 5/02

(52) U.S. Cl. CPC H04W 64/00; G01S 5/0054; G01S 5/0218

(57) ABSTRACT

A terminal includes: a control unit that performs a position measurement based on a reference signal received from a network; and a transmitting unit that transmits a report including a result of the position measurement to the network, in which the transmitting unit transmits, to the network, capability information capability of reporting an indicator concerning a line of sight of the reference signal, and the control unit assumes the position measurement based on the capability information.

### TECHNICAL FIELD

The present disclosure relates to a terminal and a radio communication method for performing position measurement based on a reference signal.

### BACKGROUND ART

The 3rd Generation Partnership Project (3GPP) has prepared a specification for the 5th generation mobile communication system (also referred to as 5G, New Radio (NR), or Next Generation (NG)), and further a specification for a next-generation system referred to as Beyond 5G, 5G Evolution, or 6G is also being prepared.

Release 16 of 3GPP prepares a specification for a protocol (NR Positioning Protocol A) for measuring a position of a terminal (hereinafter referred to as UE; User Equipment). Specifically, the UE receives a reference signal (hereinafter referred to as PRS; Positioning Reference Signal) received from a network and reports a measurement result of the PRS to the network (for example, Non-Patent Literature 1).

In addition, Release 17 of 3GPP investigates reporting of an indicator concerning the line of sight of a PRS. An environment where the line of sight of the PRS is good may be referred to as a Line of Sight (LoS) environment, and a situation where the line of sight of the PRS is poor may be referred to as a Non-Line of Sight (NLoS) environment. The indicator may be referred to as an LoS indicator or an NLoS indicator (for example, Non-Patent Literature 2).

### CITATION LIST

### Non-Patent Literature

Non-Patent Literature 1: 3GPP TS38.455 V16.4.0, 3rd Generation Partnership Project; Technical Specification Group Radio Access Network; NR; NR Positioning Protocol A (NRPPa) (Release 16), 3GPP, July 2021

Non-Patent Literature 2: “Feature Lead Summary #4 for Potential multipath/NLoS mitigation”, R1-2108629, 3GPP TSG RAN WG1 #106-e, 3GPP, August 2021

### SUMMARY OF THE INVENTION

Under this kind of background, as a result of intensive investigation, the inventors have found the necessity to clarify a specific configuration of the indicator and a UE operation regarding the indicator.

The present invention has been devised in view of such a situation and an object of the present invention is to provide a terminal and a radio communication method capable of appropriately reporting an indicator concerning the line of sight of a reference signal.

One aspect of the disclosure provides a terminal including: a control unit that performs a position measurement based on a reference signal received from a network; and a transmitting unit that transmits a report including a result of the position measurement to the network, in which the transmitting unit transmits, to the network, capability information on a capability of reporting an indicator concerning a line of sight of the reference signal, and the control unit assumes the position measurement based on the capability information.

One aspect of the disclosure provides a radio communication method including: step A of performing a position measurement based on a reference signal received from a network; step B of transmitting a report including a result of the position measurement to the network; and step C of transmitting, to the network, capability information on a capability of reporting an indicator concerning a line of sight of the reference signal, in which in the step A, the position measurement based on the capability information is assumed.

### BRIEF DESCRIPTION OF DRAWINGS

FIG. 1 is an overall schematic configuration diagram of a radio communication system 10.

FIG. 2 is a diagram showing a frequency range used in the radio communication system 10.

FIG. 3 is a diagram showing configuration examples of radio frames, subframes, and slots used in the radio communication system 10.

FIG. 4 is a functional block diagram of a UE 200.

FIG. 5 is a functional block diagram of a base station 100.

FIG. 6 is a diagram showing an operation example.

FIG. 7 is a diagram for explaining addition of an item included in a report.

FIG. 8 is a diagram for explaining addition of an item included in a report.

FIG. 9 is a diagram for explaining addition of an item included in a report.

FIG. 10 is a diagram for explaining a reporting frequency of an NLoS indicator.

FIG. 11 is a diagram for explaining a reporting frequency of an NLoS indicator.

FIG. 12 is a diagram showing an example of a hardware configuration of the base station 100 and the UE 200.

FIG. 13 is a diagram showing a configuration example of a vehicle 2001.

### DESCRIPTION OF EMBODIMENTS

Embodiments will be explained below with reference to the accompanying drawings. Note that the same or similar reference numerals have been attached to the same functions and configurations, and a description thereof will be omitted as appropriate.

### Embodiments

### (1) Overall Schematic Configuration Of Radio Communication System

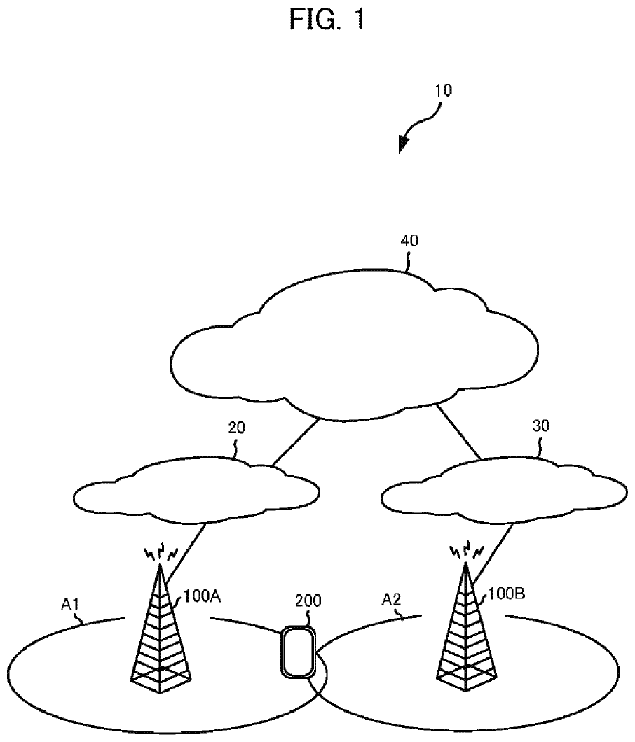

FIG. 1 is an overall schematic configuration diagram of a radio communication system 10 according to an embodiment. The radio communication system 10 is compliant with Long Term Evolution (LTE) and 5G New Radio (NR). LTE may be referred to as 4G and NR may be referred to as 5G. Further, the radio communication system 10 may be compliant with a method referred to as Beyond 5G, 5G Evolution, or 6G.

LTE and NR may be interpreted as radio access technology (RAT), and in an embodiment, LTE may be referred to as first radio access technology and NR may be referred to as second radio access technology.

The radio communication system 10 includes an Evolved Universal Terrestrial Radio Access Network 20 (hereinafter referred to as “E-UTRAN 20”) and a Next Generation-Radio Access Network 30 (hereinafter referred to as “NG-RAN 30”). Further, the radio communication system 10 includes a terminal 200 (hereinafter referred to as “UE 200”, User Equipment).

The E-UTRAN 20 includes an eNB 100A, which is a radio base station that is compliant with LTE. The NG-RAN 30 includes a gNB 100B, which is a radio base station that is compliant with 5G (NR). Further, the NG-RAN 30 may be connected to a User Plane Function (not shown) that is included in a system architecture of 5G and provides user plane functions.

The eNB 100A and gNB 100B may be referred to as radio base stations or network devices. Further, the E-UTRAN 20 and NG-RAN 30 (may be eNB 100A or gNB 100B) may simply be referred to as a network.

The E-UTRAN 20 and NG-RAN 30 are connected to a core network 40. The E-UTRAN 20, NG-RAN 30, and the core network 40 may simply be expressed as a network.

The core network 40 may include a first core network connected to the E-UTRAN 20. The first core network may be referred to as an Evolved Packet Core (EPC). The core network 40 may include a second core network connected to the NG-RAN 30. The second core network may be referred to as 5GC or 6GC.

In the radio communication system 10, the eNB 100A, gNB 100B, and UE 200 can support carrier aggregation (CA) in which a plurality of component carriers (CCs) are used and dual connectivity (DC) in which communication is performed simultaneously between the UE and each of a plurality of Nodes.

The eNB 100A, gNB 100B, and UE 200 perform radio communication via a radio bearer, specifically a Signaling Radio Bearer (SRB) or DRB Data Radio Bearer (DRB).

The UE 200 may perform E-UTRA-NR Dual Connectivity (EN-DC) in which the eNB 100A constitutes a master node (MN) and the gNB 100B constitutes a secondary node (SN), for example. The UE 200 may perform NR-E-UTRA Dual Connectivity (NE-DC) in which the gNB 100B constitutes the MN and the eNB 100A constitutes the SN. The UE 200 may perform NR-NR Dual Connectivity (NR-DC) in which the gNB constitutes the MN and SN. The EN-DC, NE-DC, and NR-DC may be referred to as Multi-Radio Dual Connectivity (MR-DC).

In the DC described above, a group of cells capable of performing processing on a C-plane (control plane) and U-plane (user plane) may be referred to as a Master cell Group (MCG), In the DC described above, a group of cells capable of performing processing on a U-plane (user plane) may be referred to as a Secondary Cell Group (SCG). A base station included in the MCG may be referred to as a MN, and a cell included in the MCG may be referred to as a master cell. A base station included in the SCG may be referred to as an SN, and a cell included in the SCG may be referred to as a secondary cell.

Further, in the radio communication system 10, addition or change of a Primary SCell (PSCell) (PSCell addition/change) may be supported. The PSCell addition/change may include conditional PSCell addition/change.

The PSCell is a type of a secondary cell. The PSCell means Primary SCell (secondary cell) and may be interpreted as corresponding to any one of a plurality of SCells.

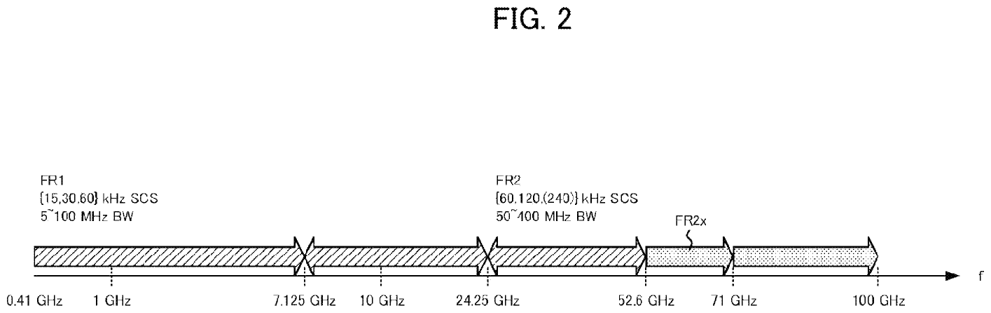

Further, the radio communication system 10 corresponds to a plurality of frequency ranges (FRs). FIG. 2 shows frequency ranges used in the radio communication system 10.

As shown in FIG. 2, the radio communication system 10 supports an FR 1 and an FR 2. Frequency bands of each FR are as follows.
FR 1:410 MHz to 7.125 GHZ
FR 2:24.25 GHz to 52.6 GHZ

In the FR 1, Subcarrier Spacing (SCS) of 15, 30, or 60kHz is used, and a bandwidth (BW) of 5 to 100 MHz may be used. The FR 2 is higher than the FR 1, an SCS of 60 or 120 kHz (240kHz may be included) is used, and a bandwidth (BW) of 50 to 400 MHZ may be used.

The SCS may be interpreted as numerology. The numerology is defined in 3GPP TS38.300 and corresponds to one subcarrier interval in a frequency domain.

In addition, the radio communication system 10 may support a frequency band which is higher than the frequency band of the FR 2. Specifically, the radio communication system 10 supports a frequency band of more than 52.6 GHZ and 71 GHz or less or 114.25 GHz or less. This kind of high frequency band may be referred to as “FR2x”, for convenience.

In order to solve a problem that an influence of phase noise increases in a high frequency band, when a band of more than 52.6 GHz is used, Cyclic Prefix-Orthogonal Frequency Division Multiplexing (CP-OFDM)/Discrete Fourier Transform-Spread (DFT-S-OFDM) with larger Subcarrier Spacing (SCS) may be applied.

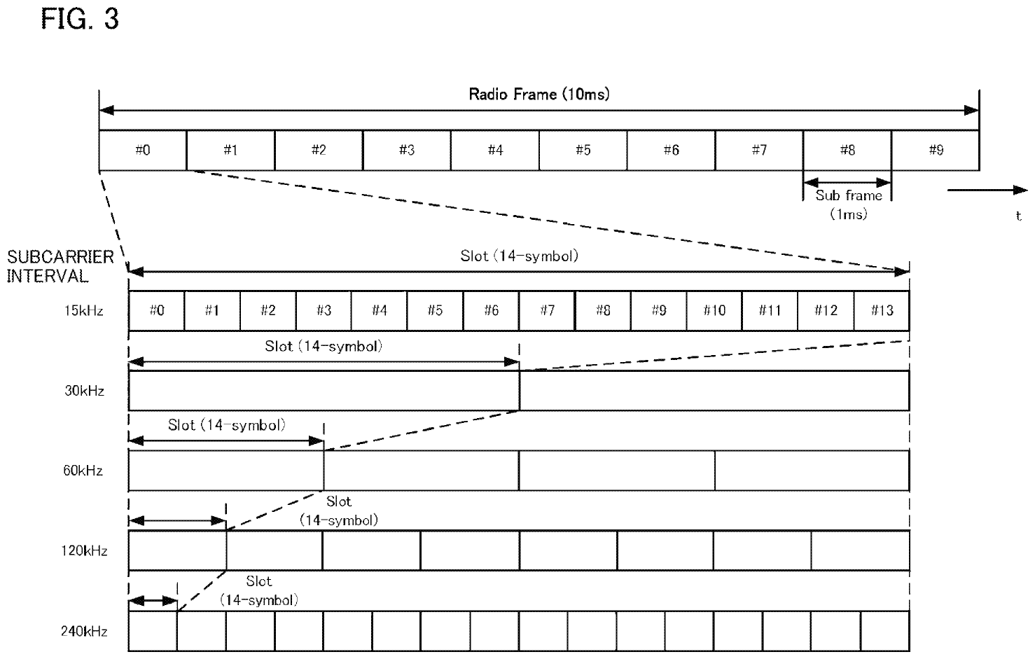

FIG. 3 is a diagram showing configuration examples of radio frames, subframes, and slots used in the radio communication system 10.

As shown in FIG. 3, 14 symbols constitute one slot, and the larger (wider) the SCS, the shorter the symbol period (and the slot period). The SCS is not limited to an interval (frequency) shown in FIG. 3. For example, 480 kHz, 960 KHz, and the like may be used.

The number of symbols constituting one slot does not necessarily have to be 14 (for example, 28, 56 symbols). In addition, the number of slots per subframe may vary depending on the SCS.

Note that a time direction (t) shown in FIG. 3 may be referred to as a time domain, symbol period, or symbol time. Further, a frequency direction may be referred to as a frequency domain, resource block, subcarrier, or Bandwidth part (BWP).

A DMRS is a type of reference signal and is prepared for various channels. In this case, unless otherwise specified, the DMRS may mean a DMRS for a downlink data channel, specifically, a DMRS for a Physical Downlink Shared Channel (PDSCH). However, a DMRS for an uplink data channel, specifically a DMRS for a Physical Uplink Shared Channel (PUSCH) may be interpreted in the same way as the DMRS for the PDSCH.

The DMRS may be used for channel estimation in the UE 200 as part of a device, for example, coherent demodulation. The DMRS may be present only in a resource block (RB) used for PDSCH transmission.

The DMRS may have a plurality of mapping types. Specifically, the DMRS has mapping type A and mapping type B. In the mapping type A, the first DMRS is allocated to a second or third symbol in a slot. In the mapping type A, the DMRS may be mapped based on a slot boundary regardless of where in the slot actual data transmission is initiated. It may be interpreted that the reason why the first DMRS is allocated to the second or third symbol in the slot is because it is necessary to allocate the first DMRS after control resource sets (CORESET).

In the mapping type B, the first DMRS may be allocated to a first symbol of data assignment. That is, a location of the DMRS may be given relative to a place where data is allocated rather than relative to a slot boundary.

Further, the DMRS may have a plurality of Types. Specifically, the DMRS has Type 1 and Type 2. Type 1 and Type 2 differ in mapping and the maximum number of orthogonal reference signals in a frequency domain. In Type 1, it is possible to output a maximum of four orthogonal signals with a single-symbol DMRS, and in Type 2, it is possible to output a maximum of eight orthogonal signals with a double-symbol DMRS.

### (2) Functional Block Configuration of Radio Communication System

Next, a functional block configuration of the radio communication system 10 will be described.

First, a functional block configuration of the UE 200 will be described.

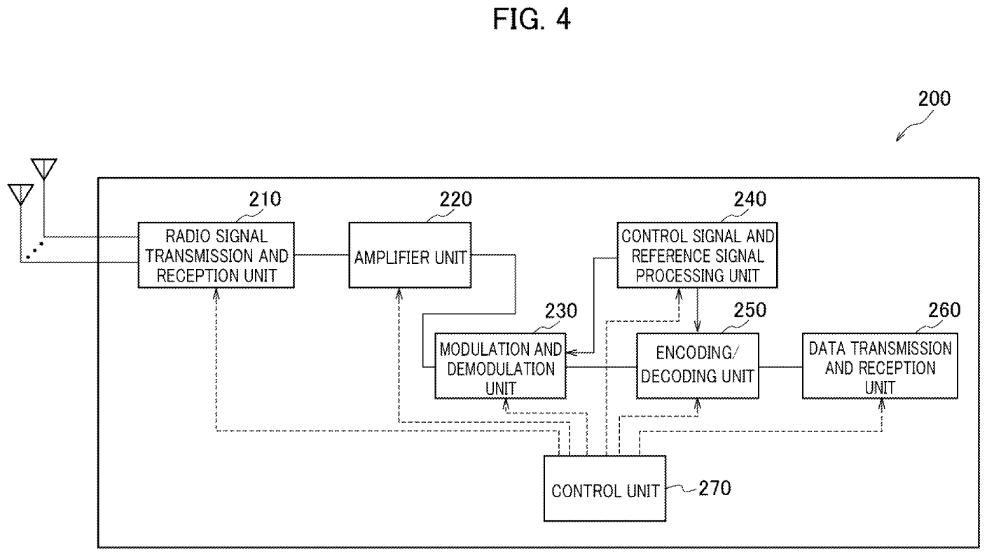

FIG. 4 is a functional block diagram of the UE 200. As shown in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals compliant with NR. The radio signal transmission and reception unit 210 supports Massive MIMO, CA in which a plurality of CCs are bundled and used, DC in which communication is performed simultaneously between the UE and each of the two NG-RAN Nodes, and the like.

The amplifier unit 220 is constituted by a Power Amplifier (PA)/a Low Noise Amplifier (LNA), or the like. The amplifier unit 220 amplifies a signal output from the modulation and demodulation unit 230 to have a predetermined power level. Further, the amplifier unit 220 amplifies an RF signal output from the radio signal transmission and reception unit 210.

The modulation and demodulation unit 230 performs data modulation/demodulation, transmission configuration, resource block allocation, and the like for each predetermined communication destination (base station). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for the uplink (UL) but also for the downlink (DL).

The control signal and reference signal processing unit 240 performs processing for various control signals transmitted and received by the UE 200 and processing for various reference signals transmitted and received by the UE 200.

Specifically, the control signal and reference signal processing unit 240 receives various control signals transmitted from the base station via a predetermined control channel, for example, control signals of a radio resource control layer (RRC). Further, the control signal and reference signal processing unit 240 transmits various control signals to the base station via the predetermined control channel.

Further, the control signal and reference signal processing unit 240 performs processing using reference signals (RSs) such as a Demodulation Reference Signal (DMRS), a Phase Tracking Reference Signal (PTRS), and the like.

The DMRS is a terminal-specific reference signal (a pilot signal) known between a base station and a terminal for estimating a fading channel used for data demodulation. The PTRS is a terminal-specific reference signal for the purpose of estimating phase noise, which becomes a problem in a high frequency band.

In addition to the DMRS and PTRS, the reference signals may include a Channel State Information-Reference Signal (CSI-RS), a Sounding Reference Signal (SRS), and a Positioning Reference Signal (PRS) for position information.

Further, the channel includes a control channel and a data channel. The control channel includes a Physical Downlink Control Channel (PDCCH), a Physical Uplink Control Channel (PUCCH), a Random Access Channel (RACH), Downlink Control Information (DCI) including a Random Access Radio Network Temporary Identifier (RA-RNTI), and a Physical Broadcast Channel (PBCH).

Further, the data channel includes a Physical Downlink Shared Channel (PDSCH), a Physical Uplink Shared Channel (PUSCH), and the like. The data means data transmitted via a data channel. The data channel may be read as a shared channel.

The control signal and reference signal processing unit 240 may receive downlink control information (DCI). The DCI includes, as existing fields, fields for storing DCI Formats, a Carrier indicator (CI), BWP indicator, Frequency Domain Resource Assignment (FDRA), Time Domain Resource Assignment (TDRA), Modulation and Coding Scheme (MCS), HARQ Process Number (HPN), New Data Indicator (NDI), Redundancy Version (RV), and the like.

A value stored in a DCI Format field is an information element that specifies a format of the DCI. A value stored in a CI field is an information element that specifies a CC to which the DCI is applied. A value stored in a BWP indicator field is an information element that specifies a BWP to which the DCI is applied. The BWP that can be specified using the BWP indicator is configured by an information element included in an RRC message (BandwidthPart-Config). A value stored in the FDRA field is an information element that specifies a frequency domain resource to which the DCI is applied. The frequency domain resource is identified by using the value stored in the FDRA field and the information element included in the RRC message (RA Type). A value stored in a TDRA field is an information element that specifies a time domain resource to which the DCI is applied. The time domain resource is identified by using the value stored in the TDRA field and the information element included in the RRC message (pdsch-TimeDomainAllocationList, pusch-TimeDomainAllocationList). The time domain resource may be identified by using the value stored in the TDRA field and a default table. A value stored in the MCS field is an information element that specifies an MCS to which the DCI is applied. The MCS is identified by using the value stored in the MCS and an MCS table. The MCS table may be specified by using the RRC message or identified by using RNTI scrambling. A value stored in an HPN field is an information element that specifies an HARQ Process to which the DCI is applied. A value stored in the NDI is an information element identifying whether the data to which the DCI is applied is initial transmission data. A value stored in an RV field is an information element that specifies redundancy of data to which the DCI is applied.

The encoding/decoding unit 250 performs data division/connection, channel coding/decoding, and the like for each predetermined communication destination (base station).

Specifically, the encoding/decoding unit 250 divides the data output from the data transmission and reception unit 260 into predetermined sizes, and performs channel coding on the divided data. Further, the encoding/decoding unit 250 decodes the data output from the modulation and demodulation unit 230 and connects the decoded data.

The data transmission and reception unit 260 transmits and receives a Protocol Data Unit (PDU) and a Service Data Unit (SDU). Specifically, the data transmission and reception unit 260 performs assembly/disassembly and the like of PDUs/SDUs in a plurality of layers (a medium access control layer (MAC), a radio link control layer (RLC), and a packet data convergence protocol layer (PDCP), and the like). Further, the data transmission and reception unit 260 performs data error correction and re-transmission control based on a Hybrid Automatic Repeat Request (HARQ).

The control unit 270 controls each functional block constituting the UE 200. In an embodiment, the control unit 270 constitutes a control unit that performs position measurement based on a reference signal received from the network (for example, eNB 100A or gNB 100B). In the following, a case in which the reference signal is the PRS will be exemplified. The position measurement may be performed in accordance with an LTE Positioning Protocol specified in 3GPP TS37.355 or in accordance with an NR Positioning Protocol A specified in 3GPP TS 38.455. The control unit 270 instructs the control signal and reference signal processing unit 240 to transmit a report including the position measurement result. The control signal and reference signal processing unit 240 may constitute a transmitting unit that transmits the report including the position measurement result to the network (for example, eNB 100A or gNB 100B).

In addition, the control signal and reference signal processing unit 240 transmits, to the network (for example, gNB 100), capability information (hereinafter referred to as “UE Capability”) on a capability of reporting an indicator concerning the line of sight of the PRS. The control unit 270 performs position measurement based on the UE Capability. An environment where the line of sight of the PRS is good may be referred to as a Line of Sight (LoS) environment, and an environment where the line of sight of the PRS is poor may be referred to as a Non-Line of Sight (NLoS) environment. The indicator may be referred to as a NLoS indicator or an NLoS indicator.

In the following, a case where the indicator is referred to as the NLoS indicator will be exemplified. The NLoS indicator is reported together with the position measurement result. In other words, the report may include both the position measurement result and the NLoS indicator.

Secondly, a functional block configuration of a base station 100 will be described. The base station 100 may be the eNB 100A or gNB 100B.

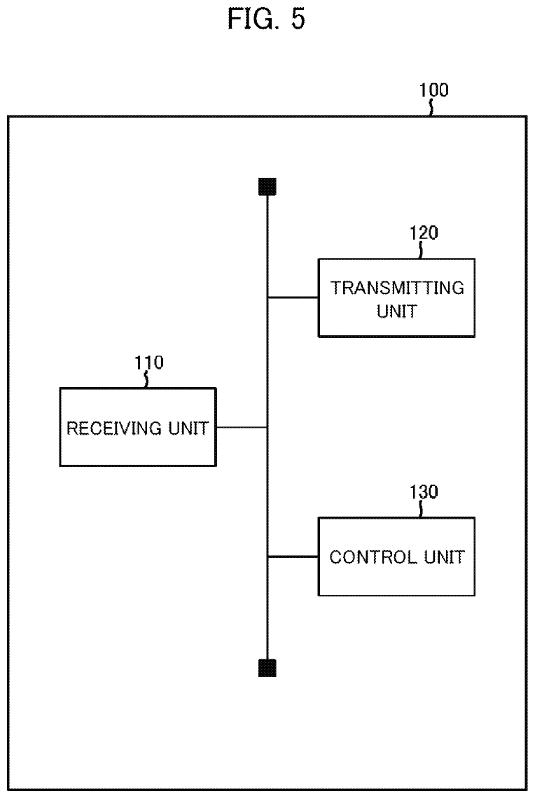

FIG. 5 is a functional block diagram of the base station 100. As shown in FIG. 5, the base station 100 includes a receiving unit 110, a transmitting unit 120, and a control unit 130.

The receiving unit 110 receives various signals from the UE 200. The receiving unit 110 may receive a UL signal via the PUCCH or PUSCH. In an embodiment, the receiving unit 110 receives, from the UE 200, the UE Capability on the capability of reporting the NLoS indicator.

The transmitting unit 120 transmits various signals to the UE 200. The transmitting unit 120 may transmit a DL signal via the PDCCH or PDSCH. In an embodiment, the transmitting unit 120 transmits the PRS to the UE 200.

The control unit 130 controls the base station 100. In an embodiment, the control unit 130 may assume that the UE 200 performs position measurement based on the UE Capability on the capability of reporting the NLoS indicator.

### (3) UE Capability

The UE Capability on the capability of reporting the NLoS indicator will be described below. As described above, the UE 200 assumes the performance of position measurement based on the UE Capability. The UE Capability may be defined based on the following options.

### (3.1) Option 1

In Option 1, the UE Capability may include an information element indicating whether to support reporting of the NLoS indicator for each predetermined unit.

In Option 1-1, the UE Capability may be defined for each UE 200. That is, whether to support reporting of the NLoS indicator may be defined for each UE 200.

In Option 1-2, the UE Capability may be defined for each frequency information used by the UE 200. The frequency information may include a frequency band. That is, whether to support reporting of the NLoS indicator may be defined for each frequency band. The frequency information may include a frequency range or the SCS.

In Option 1-3, the UE Capability may be defined for each method of performing position measurement. That is, whether to support reporting of the NLoS indicator may be defined for each method of performing position measurement. Examples of the method of performing position measurement include DL Positioning, UL Positioning, UL+DL Positioning, and the like.

The DL Positioning is a method of measuring a position of the UE 200 based on a DL-PRS. The DL Positioning may include the measurement of Time Difference of Arrival (hereinafter referred to as “TDOA”) of the DL-PRS, the measurement of Angle Of Departure (hereinafter referred to as “AOD”) of the DL-PRS, and the like. The TDOA measurement is a method of measuring a time difference of DL-PRSs received from two or more Transmission/Reception Points (TRPs). The TDOA measurement may be referred to as Reference Signal Time Difference (RSTD) measurement. The AOD measurement is a method of measuring angles of departure of DL-PRSs received from one or more TRPs. The UL Positioning is a method of measuring a position of the UE 200 based on a UL-PRS. The UL+DL Positioning is a method of measuring a position of the UE 200 based on the UL signal and DL signal. The UL+DL Positioning may include a method of measuring a position of the UE 200 based on Round Trip Time (RTT) of the UL signal and DL signal. The UL+DL Positioning may be referred to as M (Multi)-RTT. The TRP may be considered to be the eNB 100A or gNB 100B.

Options 1-2 and 1-3 described above may be combined.

### (3.2) Option 2

In Option 2, the UE Capability may include an information element on a format for reporting the NLoS indicator.

In Option 2-1, the UE Capability may include information elements on values that the NLoS indicator can take. The values that the NLoS indicator can take may be binary values represented by 0 and 1, or soft values represented in a range of 0 to 1. That is, the UE Capability may include information elements indicating whether to support binary values or soft values. The UE Capability may include information elements that support both binary values and soft values.

Although there are no particular limitations, a small value (for example, 0) may mean good line of sight and a large value (for example, 1) may mean poor line of sight. Alternatively, a small value (for example, 0) may mean poor line of sight, and a large value (for example, 1) may mean good line of sight. In the following, a case will be described in which the larger the value, the poorer the line of sight.

The values that the NLoS indicator can take may be defined for each of the predetermined units described above (Option 1-1 to Option 1-3).

In Option 2-2, the UE Capability may include an information element indicating the granularity of the NLoS indicator in a case where soft values are supported. The granularity of the NLoS indicator may be the 0.1 increment granularity, 0.2 increment granularity, 0.5 increment granularity, or the like, for example.

The granularity of the NLoS indicator may be defined for each of the predetermined units described above (Option 1-1 to Option 1-3).

In Option 2-3, the UE Capability may include an information element indicating the number of NLoS indicators supported by the UE 200. The number of NLoS indicators may be considered to be the number of position measurement results that can be included in the report.

The number of NLoS indicators may be defined for each of the predetermined units described above (Option 1-1 to Option 1-3).

### (4) Network Notification

The UE 200 may receive, from the network (for example, gNB 100), an information element for specifying an operation of the UE 200 regarding the NLoS indicator. The information element may be explicitly or implicitly included in at least one or more of an RRC message, an MAC-CE message, and DCI. The operation of the UE 200 may be specified based on the UE Capability. The specification of the operation of the UE 200 may be read as configuring, updating, indicating, activating, deactivating, or the like. The network notification (that is, specification of the operation of the UE 200) may include the following options.

### (4.1) Option 1

In Option 1, the operation of the UE 200 regarding the NLoS indicator may be specified for each predetermined unit. If the operation of the UE 200 is not specified, a default operation of the UE 200 may be determined in advance in a radio communication network 10.

In Option 1-1, the operation of the UE 200 regarding the NLoS indicator may be specified for each UE 200.

In Option 1-2, the operation of the UE 200 regarding the NLoS indicator may be specified for each frequency information used by the UE 200. The frequency information may include a frequency band. The frequency information may include a frequency range or SCS.

In Option 1-3, the operation of the UE 200 regarding the NLoS indicator may be specified for each method of performing position measurement. The method of performing position measurement may include DL Positioning, UL Positioning, UL+DL Positioning, and the like. The DL Positioning may include the TDOA measurement of a DL-PRS, the AOD measurement of a DL-PRS, and the like. The UL+DL Positioning may include M-RTT and the like.

In a case where the UL+DL Positioning is specified, if the UE 200 performs the position measurement other than the UL+DL Positioning, or if the UE 200 performs the UL+DL Positioning without reporting the NLoS indicator, the UE 200 may report the NLoS indicator, for example. In this kind of case, the UE 200 may transmit UE Capability including an information element that supports both of the DL Positioning and UL+DL Positioning, or may transmit UE Capability including an information element that supports the UL+DL Positioning without supporting the DL Positioning.

Option 1-2 and Option 1-3 described above may be combined.

### (4.2) Option 2

In Option 2, a format for reporting the NLoS indicator may be specified as an operation of the UE 200 regarding the NLoS indicator.

In Option 2-1, values that the NLoS indicator can take may be specified as the operation of the UE 200 regarding the NLoS indicator. The values that the NLoS indicator can take may be binary values represented by 0 and 1, or soft values represented in a range of 0 to 1.

The values that the NLoS indicator can take may be defined for each of the predetermined units described above (Option 1-1 to Option 1-3).

In Option 2-2, as the operation of the UE 200 regarding the NLoS indicator, in a case where soft values are supported, the granularity of the NLoS indicator may be specified.

The granularity of the NLoS indicator may be defined for each of the predetermined units described above (Option 1-1 to Option 1-3).

In Option 2-3, the number of NLoS indicators may be specified as the operation of the UE 200 regarding the NLoS indicator.

If one is specified as the number of NLoS indicators, the UE 200 may report one NLoS indicator, for example. In this kind of case, the UE 200 may transmit UE Capability including an information element for supporting reporting of two or more NLoS indicators, or may transmit UE Capability including an information element for supporting reporting of one NLoS indicator.

The number of NLoS indicators may be defined for each of the predetermined units described above (Option 1-1 to Option 1-3).

The UE 200 may report two or more NLoS indicators when performing the TDOA, and may report one NLoS indicator when performing position measurement other than the TDOA, for example. The operation of the UE 200, that is, reporting two or more NLoS indicators in performing the TDOA may be specified, and the operation of the UE 200, that is, reporting two or more NLoS indicators in performing the TDOA may be determined as a default operation, for example. In addition, the operation of the UE 200, that is, reporting two or more NLoS indicators in performing the TDOA may be specified when the operation of reporting one NLoS indicator is specified as a default operation.

### (5) Operation Example

An operation example will be described below. A case will be exemplified in which TDOA is used as the position measurement, and the number of NLoS indicators is three. As described above, an operation of the UE 200 in this kind of case may be determined based on the UE Capability or may be specified from a network.

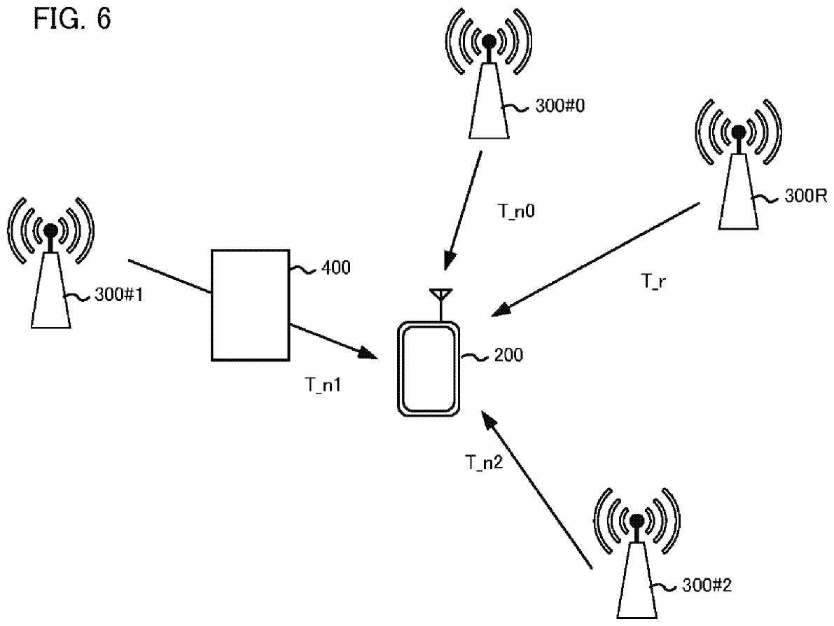

As shown in FIG. 6, the UE 200 receives PRSs from a TRP 300#R, TRP 300#0, TRP 300#1, and TRP 300#2. The TRP 300#R is a TRP that transmits a PRS, which is used as a measurement standard in the TDOA. The TRP 300#0, TRP 300#1, and TRP 300#2 are TRPs that transmit PRSs, which are used as a measurement target in the TDOA.

First, the UE 200 measures a difference between a timing (T_n0 in FIG. 6) at which a PRS is received from the TRP 300#0 and a timing (T_r in FIG. 6) at which a PRS is received from the TRP 300 #R. In addition, the UE 200 identifies an NLoS indicator (for example, 0.1) for the line of sight of the PRS received from the TRP 300#0.

Second, the UE 200 measures a difference between a timing (T_n1 in FIG. 6) at which a PRS is received from the TRP 300#1 and a timing (T r in FIG. 6) at which the PRS is received from the TRP 300#R. In addition, the UE 200 identifies an NLoS indicator (for example, 0.9) for the line of sight of the PRS received from the TRP 300#1. In FIG. 6, a case is exemplified in which the line of sight of the PRS received from the TRP 300#1 is poor due to an obstruction 400 such as a building.

Third, the UE 200 measures a difference between a timing (T_n2 in FIG. 6) at which a PRS is received from the TRP 300#2 and the timing (T_r in FIG. 6) at which the PRS is received from the TRP 300#R. In addition, the UE 200 identifies an NLoS indicator (for example, 0.3) for the line of sight of the PRS received from the TRP 300#2.

Fourth, the UE 200 transmits, to a network, reports including position measurement results. The reports include reports on the TRP 300#0 to TRP 300#2. The report on the TRP 300#0 includes a measurement result (T_n0-T_r) and an NLoS indicator (for example, 0.1). The report on the TRP 300#1 includes a measurement result (T_n1-T_r) and an NLoS indicator (for example, 0.9). The report on the TRP 300#2 includes a measurement result (T_n2-T_r) and an NLoS indicator (for example, 0.3).

In the case shown in FIG. 6, if the number of NLoS indicators is one, the UE 200 may perform the following operations. As described above, the operation of the UE 200 in this kind of case may be determined based on the UE Capability or may be specified from a network.

First, the UE 200 may transmit an NLoS indicator (for example, 0.1) having the smallest value to the network. Alternatively, the UE 200 may transmit an NLoS indicator (for example, 0.9) having the largest value to the network.

Second, if the number of NLoS indicators indicating an NLoS environment is equal to or greater than a threshold P, the UE 200 may transmit one NLoS indicator indicating the NLoS environment to the network. If values that the NLoS indicator can take are binary values, the number of NLoS indicators indicating the NLoS environment may be one. If values that the NLoS indicator can take are soft values, the NLoS indicator indicating the NLoS environment may be an NLoS indicator having a value that is equal to or greater than a threshold Q.

In this kind of case, the threshold P may be defined in advance in a radio network 10 and may be specified explicitly or implicitly by at least one or more of an RRC message, an MAC-CE message, and DCI. The specification of the threshold P may be read as configuring, updating, indicating, activating, deactivating, or the like. Similarly, the threshold Q may be defined in advance in the radio network 10 and may be specified explicitly or implicitly by at least one or more of an RRC message, an MAC-CE message, and DCI. The specification of the threshold Q may be read as configuring, updating, indicating, activating, deactivating, or the like.

Third, the UE 200 may transmit, to the network, an average value of the NLoS indicator (for example, 0.43˜(0.1+0.9+0.3)/3).

Fourth, an NLoS indicator for one TRP to be reported may be transmitted to the network. The TRP to be reported may be defined in advance in the radio network 10 and may be specified explicitly or implicitly by at least one or more of an RRC message, an MAC-CE message, and DCI. The specification of the TRP may be read as configuring, updating, indicating, activating, deactivating, or the like. The TRP to be reported may be a Serving cell, for example.

### (6) State Information

State information on the line of sight of a PRS will be described below. The UE 200 may receive state information on the line of sight of a PRS from the network (eNB 100A or gNB 100B). The state information is identified based on an NLoS indicator reported to the network. The state information may be information associated with a value of an NLoS indicator, or may be a value calculated based on a value of an NLoS indicator.

The state information may be defined for each DL-PRS resource, for each DL-PRS resource set, or for each TRP.

The state information may be explicitly or implicitly notified by at least one or more of an RRC message, an MAC-CE message, and DCI.

Values that the state information can take may be binary values represented by 0 and 1, or soft values represented in a range of 0 to 1. If values that the state information can take are soft values, the granularity of the state information may be set separately from the granularity of the NLoS indicator. The granularity of the state information may be the same as the granularity of the NLoS indicator or different from the granularity of the NLoS indicator.

### (7) Addition of Item

An item to be added to a report to the network (eNB 100A or gNB 100B) will be described below. The UE 200 adds an item to be included in a report, based on the line of sight of a PRS. The line of sight of the PRS may be identified by an NLoS indicator or by state information.

In a case where the AOD measurement is performed as the position measurement, when the NLoS environment is assumed, the UE 200 may add an item regarding an angular difference of beams of two or more PRSs, for example. If the NLoS indicator is equal to or greater than a threshold T, the UE 200 may assume the NLoS environment. If the state information is equal to or greater than the threshold T, the UE 200 may assume the NLoS environment.

The threshold T may be defined in advance in the radio network 10 and may be specified explicitly or implicitly by at least one or more of an RRC message, an MAC-CE message, and DCI. The specification of the threshold T may be read as configuring, updating, indicating, activating, deactivating, or the like.

The angular difference of beams of two or more PRSs may be considered to be an angular difference between a first beam and a second beam. The first beam may be an Rx beam having the maximum RSRP/RSRQ among Rx beams of PRSs assumed to be in an LoS environment. The second beam may be an Rx beam having the maximum RSRP/RSRQ among Rx beams of PRSs assumed to be in the NLoS environment.

In this kind of case, the following options can be considered as the angular difference of beams of two or more PRSs.

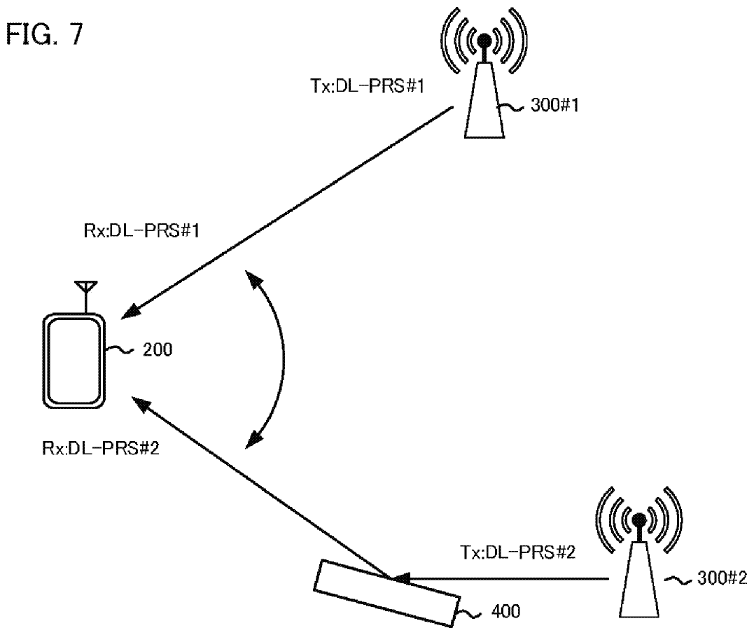

In Option 1, as shown in FIG. 7, two or more PRSs may be PRSs received from different TRPs 300.

When the NLoS environment is assumed, the UE 200 may add an angular difference between a received beam (Rx: DLPRS#1) of a PRS received from the TRP 300#1 and a received beam (Rx: DLPRS#2) of a PRS received from the TRP 300#2, for example. FIG. 7 exemplifies a case in which a TRP transmitted from the TRP 300#2 is reflected by the obstruction 400.

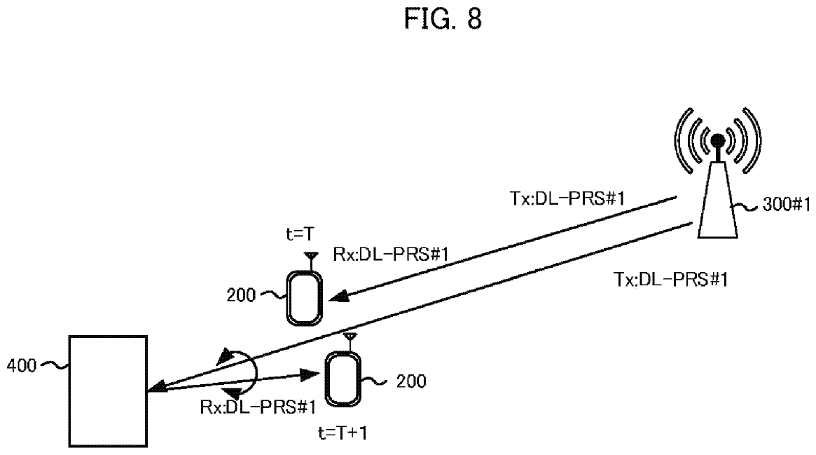

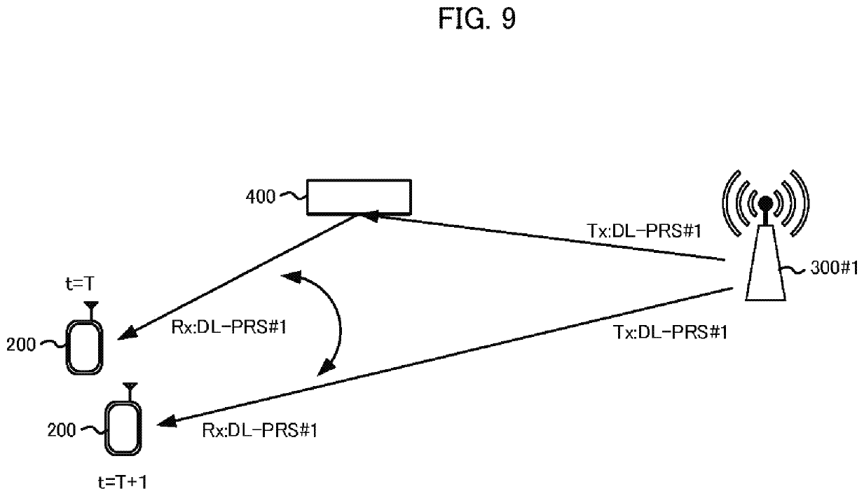

In Option 2, as shown in FIGS. 8 and 9, two or more PRSs may be PRSs received from the same the TRP 300 at different times.

As shown in FIG. 8, when the NLoS environment is assumed, the UE 200 may add an angular difference between a received beam (Rx: DLPRS #1) of a PRS received from the TRP #1 at time t=T, and a received beam (Rx: DLPRS #1) of a PRS received from the TRP #1 at time t=T+1, for example. FIG. 8 exemplifies a case in which a TRP transmitted from the TRP 300 #1 is reflected by the obstruction 400 in an opposite direction at time t=T+1.

Alternatively, as shown in FIG. 9, when the NLoS environment is assumed, the UE 200 may add an angular difference between a received beam (Rx: DLPRS #1) of a PRS received from the TRP #1 at time t=T, and a received beam (Rx: DLPRS #1) of a PRS received from the TRP #1 at time t=T+1. FIG. 9 exemplifies a case in which a TRP transmitted from the TRP 300#1 is reflected by the obstruction 400 by an angle of about 120 degrees at time t=T.

### (8) Frequency

A reporting frequency of an NLoS indicator will be described below. The reporting frequency of the NLoS indicator may be periodic or aperiodic.

The UE 200 may specify the reporting frequency of the NLoS indicator based on an information element received from the network. The information element may be an information element for specifying a reporting frequency of an NLoS indicator. The information element may be explicitly or implicitly included in at least one or more of an RRC message, an MAC-CE message, and DCI. The specification of the reporting frequency of the NLoS indicator may be read as configuring, updating, indicating, activating, deactivating, or the like. The UE 200 may request the network to update or change the reporting frequency of the NLoS indicator.

First, a case will be described in which the reporting frequency of the NLoS indicator is periodic. A reporting period of the NLoS indicator may be specified explicitly or implicitly by at least one or more of an RRC message, an MAC-CE message, and DCI.

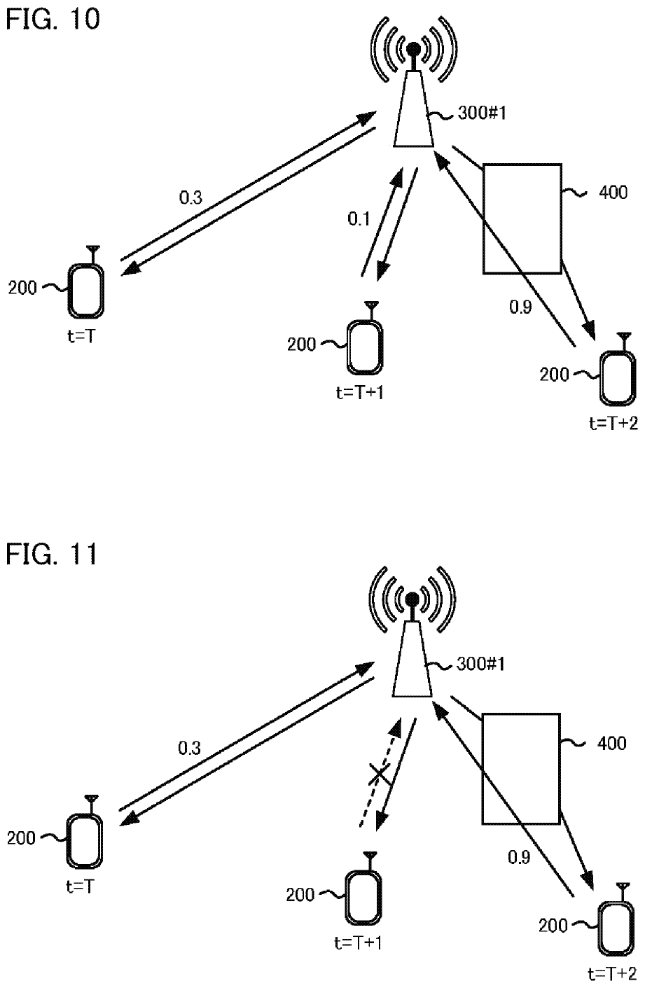

As shown in FIG. 10, the UE 200 may report an NLoS indicator (0.3) at time t=T, an NLoS indicator (0.1) at time t=T+1, and an NLoS indicator (0.9) at time t=T+2, for example.

In this kind of case, a method of performing position measurement may be updated or changed based on the line of sight of a PRS. Specifically, the network may specify a method of performing position measurement based on the line of sight of a PRS. The line of sight of a PRS may be specified by an NLoS indicator or by state information.

The network may specify the AOD measurement if the NLoS indicator (or state information) is less than a threshold T_m1, may specify the TDOA measurement if the NLoS indicator (or state information) is the threshold T_m1 or more and less than a threshold T_m2, and may specify M-RTT measurement if the NLoS indicator (or state information) is the threshold T_m2 or more and less than a threshold T_m3, for example.

Alternatively, the network may specify the M-RTT measurement if the NLoS indicator (or state information) is less than the threshold T_m1, may specify the TDOA measurement in addition to the M-RTT measurement if the NLoS indicator (or state information) is the threshold T_m1 or more and less than the threshold T_m2, and may specify the AOD measurement in addition to the M-RTT measurement and TDOA measurement if the NLoS indicator (or state information) is the threshold T_m2 or more and less than the threshold T_m3.

In this kind of case, when two or more position measurements are specified, a weighted value applied to each of the two or more position measurements may be determined based on a value of the NLoS indicator (or state information).

In the case described above, thresholds such as the threshold T_m1 to threshold T_m3 may be specified explicitly or implicitly by at least one or more of an RRC message, an MAC-CE message, and DCI.

Second, a case will be described in which the reporting frequency of the NLoS indicator is aperiodic. The following options may be considered as this kind of case.

In Option 1, if the line of sight of a PRS changes, the UE 200 may report the NLoS indicator. If the line of sight of a PRS does not change, the UE 200 may omit reporting of the NLoS indicator. The following options may be considered as cases where the line of sight of a PRS changes.

In Option 1-1, the line of sight of a PRS may be distinguished into the NLoS environment and LoS environment. The NLoS environment and LoS environment may be distinguished by state information notified by the network. If the NLoS environment changes to the LoS environment, the UE 200 may report the NLoS indicator, and alternatively if LoS environment changes to the NLoS environment, the UE 200 may report the NLoS indicator, for example. If the line of sight of a PRS does not change, the UE 200 may omit reporting of the NLoS indicator.

In Option 1-2, the change in the line of sight of a PRS may be that values of two NLoS indicators change by a threshold T_i or more. The two NLoS indicators may be NLoS indicators that are identified at temporally different timing. That is, if the values of the two NLoS indicators change by the threshold T_i or more, the UE 200 may report the NLoS indicator. Alternatively, if the values of the two NLoS indicators do not change by the threshold T_i or more, the UE 200 may omit reporting of the NLoS indicator. The threshold T_i may be specified explicitly or implicitly by at least one or more of an RRC message, an MAC-CE message, and DCI.

Option 1-3 may be a combination of Option 1-1 and Option 1-2 described above.

Taking Option 1-1 as an example, if a threshold for distinguishing between the NLoS environment and LoS environment is 0.2, as shown in FIG. 11, at time t=T, the UE 200 may report an NLoS indicator (0.3), for example. At time t=T+1, the UE 200 may omit reporting of the NLoS indicator because the LoS environment does not change. At time t=T+1, the UE 200 may report an NLoS indicator (0.9) because the LoS environment changes to the NLoS environment.

Taking Option 1-2 as an example, if the threshold T_i for defining the change in the line of sight of a PRS is 0.5, as shown in FIG. 11, at time t=T, the UE 200 may report an NLoS indicator (0.3). At time t=T+1, the UE 200 may omit reporting of the NLoS indicator because a value of the NLoS indicator does not change by the threshold T_i or more. At time t=T+1, the UE 200 may report an NLoS indicator (0.9) because a value of the NLoS indicator changes by the threshold T_i or more.

In Option 1-4, a default state of the line of sight of a PRS may be defined. The default state may be defined in advance in the radio network 10 and may be specified explicitly or implicitly by at least one or more of an RRC message, an MAC-CE message, and DCI. In this kind of case, the UE 200 may report the NLoS indicator if the line of sight of a PRS changes from the default state, and the UE 200 may omit reporting of the NLoS indicator until a timer expires if the line of sight of a PRS does not change from the default state. The timer may be triggered by reporting of the NLoS indicator. Whether the line of sight of a PRS has changed from the default state may be determined in the same manner as Option 1-1 or Option 1-2.

In Option 1-5, the UE 200 may report the NLoS indicator if the line of sight of a PRS has changed, and the changed line of sight continues over a certain period of time. In other words, the UE 200 may omit reporting of the NLoS indicator if the line of sight of a PRS has changed, and the changed line of sight does not continue over a certain period of time. The certain period of time may be defined in advance by the radio network 10 and may be specified explicitly or implicitly by at least one or more of an RRC message, an MAC-CE message, and DCI. The certain period of time may be defined to be N times (N is a positive integer) of a DL-PRS measurement occasion.

According to Option 1-5, it is possible to suppress frequent reporting of the NLoS indicator if the line of sight of a PRS changes frequently in the vicinity of a threshold for defining the change in the line of sight of the PRS, for example.

In Option 1-1 to Option 1-5 described above, the line of sight of a PRS is identified by the NLoS indicator. However,

Option 1 to Option 1-5 are not limited thereto. The line of sight of a PRS may be identified by state information, or may be identified by both of the state information and NLoS indicator.

### (9) Action and Effect

In an embodiment, the UE 200 transmits, to the network, the UE Capability for reporting the NLoS indicator concerning the line of sight of a PRS and assumes the position measurement based on the UE Capability. With this kind of configuration, the NLoS indicator can be operated appropriately.

In an embodiment, the UE Capability may be defined based on a parameter of at least any one of a frequency band of a PRS, a method of performing position measurement, and a format for reporting an NLoS indicator. According to this kind of configuration, it is possible to flexibly operate the NLoS indicator.

In an embodiment, the UE 200 may receive state information on the line of sight of a PRS. The state information may be specified based on the NLoS indicator. According to this kind of configuration, it is possible to contribute to enhancement of the accuracy of the line of sight of a PRS.

In an embodiment, the UE 200 may add an item included in a report, based on the line of sight of a PRS. According to this kind of configuration, it is possible to contribute to enhancement of the accuracy of position measurement of the UE 200.

In an embodiment, the UE 200 may specify a reporting frequency of an NLoS indicator based on an information element received from a network. According to this kind of configuration, the NLoS indicator can be operated appropriately.

### (10) Other Embodiments

Although the contents of the present invention have been described in accordance with the embodiment, the present invention is not limited to the descriptions, and it is obvious to those skilled in the art that various modifications and improvements are possible.

In the above disclosure, the network may be read as the base station 100, the TRP 300, or a Location Management Function (LMF).

In the above disclosure, a case has been exemplified in which the smaller a value of the NLoS indicator, the better the line of sight of a PRS. However, the above disclosure is not limited thereto. The larger a value of the NLoS indicator is, the better the line of sight of a PRS may be. In this kind of case, a large/small relationship regarding a comparison between an NLoS indicator and a threshold may be reversed.

In the above disclosure, a case has been exemplified in which an indicator concerting the line of sight is the NLoS indicator. However, the above disclosure is not limited thereto. The indicator concerning the line of sight may be referred to as an LoS/NLoS indicator or may be referred to as a path status indicator.

In the above disclosure, the state information may be referred to as status info., NLoS status info., LoS/NLoS status info., or environment info.

In the above disclosure, a case has been exemplified in which the smaller a value of state information, the better the line of sight of a PRS. However, the above disclosure is not limited thereto. The larger a value of the state information is, the better the line of sight of a PRS may be. In this kind of case, a large/small relationship regarding a comparison between state information and a threshold may be reversed.

In the above disclosure, the DL Positioning, UL Positioning, UL+DL Positioning, and the like have been exemplified as the method of performing position measurement. However, the method of performing position measurement may be further subdivided. The method of performing position measurement may be considered to be the TDOA of DL Positioning, AOD of DL Positioning, M-RTT of UL+DL Positioning, and the like, for example.

The block diagram (FIGS. 4 and 5) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions deciding, determining, include judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

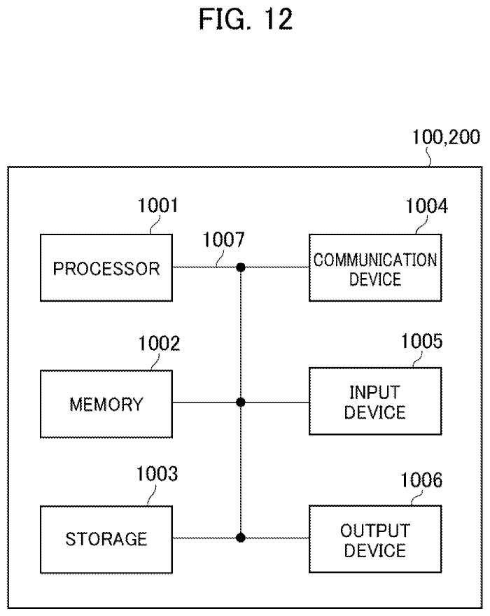

Further, the above-described base station 100 and UE 200 (the device) may as a computer that performs processing of a radio communication method of the present disclosure. FIG. 12 is a diagram illustrating an example of a hardware configuration of the device. As illustrated in FIG. 12, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIG. 4) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16(WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IOT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a base station. In this case, the base station may have the function of the mobile station.

A radio frame may be composed of one or more frames in the time domain. Each of the one or more frames in the time domain may be referred to as a subframe.

A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1subframe, or 1 TTI. Each TTI, subframe, or the like may be composed of one or more resource blocks.

Note that, one or more RBs may be called a physical resource block (PRB), a subcarrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

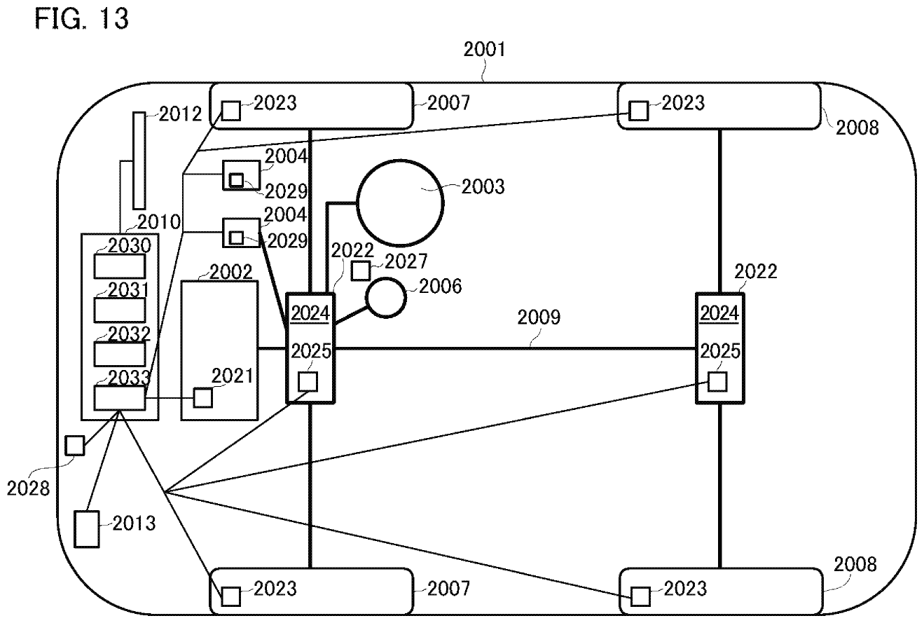

FIG. 13 shows a configuration example of a vehicle 2001. As shown in FIG. 13, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor.

The steering 2003 includes at least a steering wheel (also called a handle) and steers at least one of the front and rear wheels based on an operation of a steering wheel operated by a user.

The electronic controller 2010 includes a microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a light detection and ranging (LiDAR), a camera, a positioning locator (for example, GNSS), map information (for example, high-definition (HD) maps, autonomous vehicle (AV) maps, and the like), a gyroscopic system (for example, an inertial measurement unit (IMU), an inertial navigation system (INS), and the like), an artificial intelligence (AI) chip, and an AI processor for providing functions to prevent accidents or reduce a driving load of a driver, and one or more ECUs for controlling these devices. Further, the driver support system unit 2030 transmits and receives various of kinds information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a base station, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like. provided in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### Reference Signs List

10 Radio communication system
20 E-UTRAN
30 NG-RAN
40 Core network
100A eNB
100B gNB
100 Base station
110 Receiving unit
120 Transmitting unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
300 TRP
400 Obstruction
1001 Processor
1002 Memory
1003 Storage
1004 Communication device
1005 Input device
1006 Output device
1007 Bus
2001 Vehicle
2002 Driving unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Rotation speed sensor
2033 Air pressure sensor
2024 Vehicle speed sensor
2025 Acceleration sensor
2026 Brake pedal sensor
2027 Shift lever sensor
2028 Object detection sensor
2029 Accelerator pedal sensor
2030 Operation support system
2031 Microprocessor
2032 Memory (ROM, RAM)
2033 Communication port

1. A terminal comprising:
a control unit that performs a position measurement based on a reference signal received from a network; and
a transmitting unit that transmits a report including a result of the position measurement to the network, wherein
the transmitting unit transmits, to the network, capability information on a capability of reporting an indicator concerning a line of sight of the reference signal, and
the control unit assumes the position measurement based on the capability information.

2. The terminal according to claim 1, wherein
the capability information is defined based on a parameter of at least any one of information on a frequency used by the terminal, a method of performing the position measurement, and a format for reporting the indicator.

3. The terminal according to claim 1, comprising:
a receiving unit that receives state information on the line of sight of the reference signal from the network, wherein
the state information is identified based on the indicator.

4. The terminal according to claim 1, wherein
the control unit adds an item to be included in the report, based on the line of sight of the reference signal.

5. The terminal according to claim 1, wherein
the control unit identifies a reporting frequency of the indicator based on an information element received from the network.

6. A radio communication method comprising:
step A of performing a position measurement based on a reference signal received from a network;
step B of transmitting a report including a result of the position measurement to the network; and
step C of transmitting, to the network, capability information on a capability of reporting an indicator concerning a line of sight of the reference signal, wherein
in the step A, the position measurement based on the capability information is assumed.

7. The terminal according to claim 2, comprising:
a receiving unit that receives state information on the line of sight of the reference signal from the network, wherein
the state information is identified based on the indicator.

8. The terminal according to claim 2, wherein
the control unit adds an item to be included in the report, based on the line of sight of the reference signal.

9. The terminal according to claim 3, wherein
the control unit adds an item to be included in the report, based on the line of sight of the reference signal.

10. The terminal according to claim 2, wherein
the control unit identifies a reporting frequency of the indicator based on an information element received from the network.

11. The terminal according to claim 3, wherein
the control unit identifies a reporting frequency of the indicator based on an information element received from the network.

12. The terminal according to claim 4, wherein
the control unit identifies a reporting frequency of the indicator based on an information element received from the network.
